(19) United States
(12) Patent Application Publication
(10) Pub. No.: US 2026/0169329 A1
(43) Pub. Date: Jun. 18, 2026

(54) DISPLAY DEVICE

(71) Applicant: LG Display Co., Ltd., Seoul (KR)

(72) Inventors: Seung Han PAEK, Paju-si (KR); Sang Pyo HONG, Paju-si (KR); Hyun Jin AN, Paju-si (KR); Kyung Jae YOON, Paju-si (KR); Jeon Phill HAN, Paju-si (KR)

(21) Appl. No.: 19/373,552

(22) Filed: Oct. 29, 2025

(30) Foreign Application Priority Data
Dec. 12, 2024 (KR) 10-2024-0184355

(51) Int. Cl. G02F 1/1339; G02F 1/1362

(52) U.S. Cl. CPC G02F 1/1339; G02F 1/136286

(57) ABSTRACT

A display device includes a display panel including a groove and a circuit board connected to the display panel. The display panel includes: a first substrate including a first area and a second area spaced apart from each other by the groove; a circuit layer arranged on the first area and including a transistor; a planarization layer extending in the circuit layer to be arranged over the groove; a bending wire arranged on the planarization layer; a first protective layer arranged over the bending wire; and a second substrate arranged over the first protective layer to overlap the first area and the second area of the first substrate.

### CROSS-REFERENCE TO RELATED APPLICATION

Pursuant to 35 U.S.C. § 119 (a), this application claims the benefit of an earlier filing date and right of priority to Korean Patent Application No. 10-2024-0184355, filed in the Republic of Korea on Dec. 12, 2024, the disclosure of which is incorporated herein by reference in its entirety.

### TECHNICAL FIELD

The present disclosure relates to a display panel and a display device including the same.

### BACKGROUND

With the development of information technology, many related technologies have been developed in the field of display devices for visually displaying information, such as text, images, video, or graphical data. A display device is an output device that converts electrical signals into visible light patterns, typically using an array of pixels composed of sub-pixels.

### SUMMARY

A display device according to an example of the present disclosure includes a display panel including a groove and a circuit board connected to the display panel. The display panel includes: a first substrate including a first area and a second area spaced apart from each other by the groove; a circuit layer arranged on the first area and including a transistor; a planarization layer extending in the circuit layer to be arranged over the groove; a bending wire arranged on the planarization layer; a first protective layer arranged over the bending wire; and a second substrate arranged over the first protective layer to overlap the first area and the second area of the first substrate.

According to the present disclosure, the first substrate and the second substrate having the same or similar size as the first substrate may reduce the size of a non-display area (or bezel area) to implement a maximum screen on which an image is implemented.

According to the present disclosure, a narrow bezel may be implemented by applying a pad portion to one side of a substrate including the groove and by bending a portion of the substrate on which the pad portion is arranged.

According to the present disclosure, the bending wire arranged in a bending area may prevent damage to or minimize or reduce the possibility of damage to a connection wire due to bending. Furthermore, the first protective layer arranged over the bending area may prevent damage to or minimize or reduce the possibility of damage the bending wire and the connection wire. Accordingly, examples according to the present disclosure may improve the durability of the display panel through use of the bending wire and the first protective layer, thereby improving the lifetime of the display panel.

According to the present disclosure, the rigidity of a substrate may be maintained by processing a substrate made of a glass material through an etching process.

Various useful advantages and effects of the examples of the present disclosure are not limited to the above-described contents, and effects which are not described above will be clearly understood by those skilled in the art from the following descriptions.

Other systems, methods, features, and advantages will be, or will become, apparent to one with skill in the art upon examination of the following figures and detailed description. It is intended that all such additional systems, methods, features and advantages be included within this description, be within the scope of the present disclosure, and be protected by the following claims. Nothing in this section should be taken as a limitation on those claims. Further aspects and advantages are discussed below in conjunction with examples of the disclosure.

It is to be understood that both the foregoing general description and the following detailed description are exemplary and explanatory and are intended to provide further explanation of the inventive concepts as claimed.

### BRIEF DESCRIPTION OF THE DRAWINGS

The above and other objects, features, and advantages of the present disclosure will become more apparent to those of ordinary skill in the art by describing examples thereof in detail with reference to the attached drawings, in which:

FIG. 1 is a view illustrating a display device according to an example of the present disclosure;

FIG. 2 is a plan view illustrating an arrangement relationship among connection wires, bending wires and pad portions in a display panel according to an example of the present disclosure;

FIG. 3 is a cross-sectional view taken along line I-I′ in FIG. 2 according to an example of the present disclosure;

FIG. 4 is an enlarged view of an area A in FIG. 3 according to an example of the present disclosure;

FIG. 5 is a view showing a neutral plane according to bending according to an example of the present disclosure;

FIGS. 6A-6C are views illustrating a manufacturing process of the display panel according to the example of the present disclosure.

FIG. 7 is a view illustrating a coating layer arranged in the display panel according to the example of the present disclosure;

FIG. 8 is a view illustrating the arrangement relationship between a first protective layer and a planarization layer arranged in a display panel according to another example of the present disclosure;

FIG. 9 is a view illustrating a bent appearance of the display device according to the example of the present disclosure;

FIG. 10 is a view illustrating a case of the display device according to the example of the present disclosure;

FIG. 11 is a cross-sectional view illustrating a display panel according to another example of the present disclosure;

FIG. 12 is an enlarged view of an area B in FIG. 11 according to another example of the present disclosure;

FIG. 13 is a view illustrating a bent appearance of a display device to which another example of the display panel according to the example of the present disclosure is applied;

FIG. 14 is a cross-sectional view illustrating a display panel according to another example of the present disclosure;

FIG. 15 is an enlarged view of an area C in FIG. 14 according to another example of the present disclosure; and

FIG. 16 is a view illustrating a bent appearance of a display device to which another example of the display panel according to the example of the present disclosure is applied.

### DETAILED DESCRIPTION

Display devices can be used as display screens of an electronic device, such as a mobile communication terminal, an electronic notebook, an electronic book, a portable multimedia player (PMP), a navigation device, an ultra-mobile personal computer (UMPC), a mobile phone, a tablet personal computer (PC), a watch phone, an electronic pad, a wearable device, a portable information device, a vehicle control display device, a television, a notebook, a monitor, and the like. Research and development have been conducted developing display devices capable of implementing a maximum screen size by reducing a bezel area where an image is not displayed at the same display panel size.

Examples of the present disclosure provide a display panel and a display device including the same that may implement a maximum screen by structurally reducing a non-display area (or bezel area) that does not display an image.

Examples of the present disclosure provide a display panel and a display device including the same that implements a narrow bezel by applying a pad portion to one side of a substrate including a groove and by bending a portion of the substrate on which the pad portion is arranged.

Examples of the present disclosure provide a display panel and a display device including the same that may prevent damage to or minimize or reduce the possibility of damage to a connection wire due to bending through use of a bending wire arranged in a bending area.

Examples of the present disclosure provide a display panel and a display device including the same that may prevent damage to or minimize or reduce the possibility of damage to a connection wire due to bending through use of a first protective layer located on a bending area.

The objectives to be solved by the examples of the present disclosure are not limited to the objectives mentioned above, and other objectives not mentioned will be clearly understood by those skilled in the art from the following descriptions.

Reference will now be made in detail to examples of the present disclosure, which may be illustrated in the accompanying drawings. In the following description, when a detailed description of well-known functions or configurations related to this document is determined to unnecessarily cloud a gist of the inventive concept, the detailed description thereof will be omitted or may be briefly discussed. The progression of processing steps and/or operations described is an example; however, the sequence of steps and/or operations is not limited to that set forth herein and may be changed as is known in the art, with the exception of steps and/or operations necessarily occurring in a particular order. Like reference numerals designate like elements throughout. Names of the respective elements used in the following explanations may be selected only for convenience of writing the specification and may be thus different from those used in actual products.

The advantages and features of the present disclosure and methods for accomplishing the same will be more clearly understood from examples described below with reference to the accompanying drawings. However, the present disclosure is not limited to the following examples but may be implemented in various different forms. Rather, the present examples will make the disclosure of the present disclosure complete and allow those skilled in the art to completely comprehend the scope of the present disclosure. The present disclosure is only defined within the scope of the accompanying claims.

Shapes, sizes, ratios, angles, numbers, and the like disclosed in the accompanying drawings for describing the examples of the present disclosure are illustrative, and the present disclosure is not limited to the illustrated items. Like reference numerals refer to like elements throughout. In addition, in describing the present disclosure, if it is determined that the detailed description of the related known technology may unnecessarily obscure the subject matter of the present disclosure, the detailed description thereof will be omitted.

Any implementation described herein as an “example” is not necessarily to be construed as preferred or advantageous over other implementations.

The terms such as “comprising”, “including”, and “having” used herein are generally intended to allow other components to be added unless the terms are used with the term “only”. References to the singular shall be construed to include the plural unless expressly stated otherwise.

In interpreting a component, it is interpreted to include an error range even if there is no separate description.

When describing a positional or interconnected relationship between two components, such as “on top of”, “above”, “below”, “next to”, “connect or couple with”, “crossing”, “intersecting” etc., one or more other components may be interposed between them unless “immediately” or “directly” is used.

When describing a temporal contextual relationship is described, such as “after”, “following”, “next to” or “before”, it may not be continuous on a time scale unless “immediately” or “directly” is used.

The terms “first”, “second” and the like may be used to distinguish components from each other, but the functions or structures of the components are not limited by ordinal numbers or component names in front of the components.

Also, when an element or layer is “connected,” “coupled,” or “attached” to another element or layer denotes that the element or layer can not only be directly connected or adhered to the other element or layer, but also be indirectly connected or adhered to the other element or layer with one or more intervening elements or layers “disposed,” or “interposed” between the elements or layers, unless otherwise specified. It should be understood to mean that elements may be so disposed to directly contact each other, or may be so disposed without directly contacting each other.

The expression of a first element, a second element, “and/or” a third element should be understood as one of the first, second, and third elements or as any or all combinations of the first, second, and third elements. By way of example, A, B, and/or C can refer to only A; only B; only C; any or some combination of A, B, and C; or all of A, B, and C.

The term “at least one” should be understood as including any and all combinations of one or more of the associated listed items. For example, the meaning of “at least one of a first element, a second element, and a third element” encompasses the combination of all three listed elements, combinations of any two of the three elements, as well as each individual element, the first element, the second element, or the third element.

Unless otherwise defined, all terms (including technical and scientific terms) used herein have the same meaning as commonly understood by one of ordinary skill in the art to which example examples belong. It will be further understood that terms, such as those defined in commonly used dictionaries, should be interpreted as having a meaning for example consistent with their meaning in the context of the relevant art and should not be interpreted in an idealized or overly formal sense unless expressly so defined herein. For example, the term “part” or “unit” may apply, for example, to a separate circuit or structure, an integrated circuit, a computational block of a circuit device, or any structure configured to perform a described function as should be understood to one of ordinary skill in the art.

Rather, these examples may be provided so that this disclosure may be sufficiently thorough and complete to assist those skilled in the art to fully understand the scope of the present disclosure. Furthermore, the present disclosure is only defined by scopes of claims.

The following examples may be combined or associated with each other in whole or in part, and various types of interlocking and driving are technically possible. The examples may be implemented independently of each other or together in an interrelated relationship.

Hereinafter, preferred examples of the present disclosure will be described in detail with reference to the accompanying drawings.

A display device according to an example in this disclosure may include a display device itself in a narrow sense, an application product including a display in a narrow sense, or even a set device that is an end-consumer device.

The display device according to the example of the present disclosure may be implemented with a liquid crystal display device (LCD), a plasma display panel device (PDP), a field emission display device (FED), an electroluminescence display device (ELD), an organic light emitting diodes (OLED), a quantum dot display, a micro light emitting diode (micro LED) display, or the like. For example, the display area DA of the display device according to the example of the present disclosure is exemplified by a liquid crystal display utilizing a liquid crystal layer, but not necessarily limited thereto. For example, the display area DA may be implemented with any one of OLED, QLED, and Micro LED.

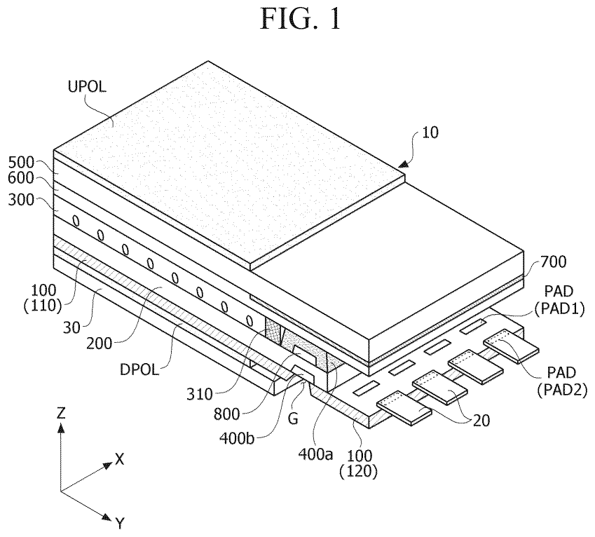

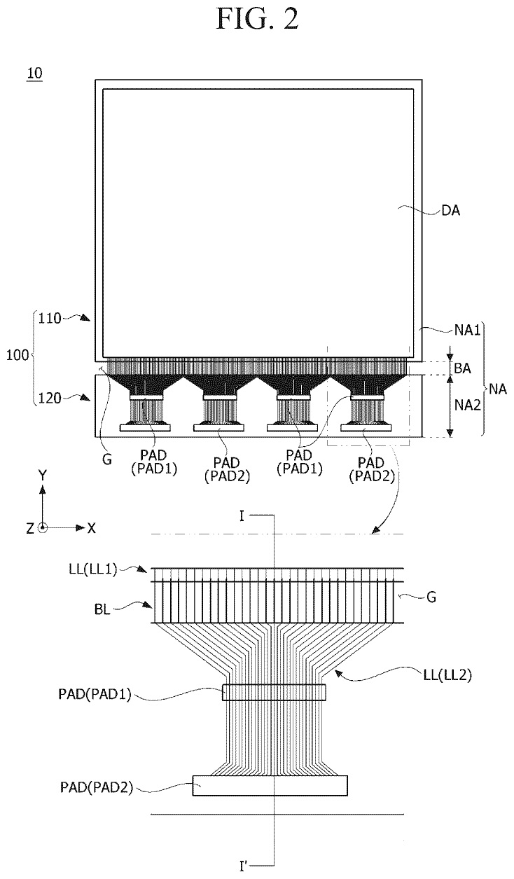

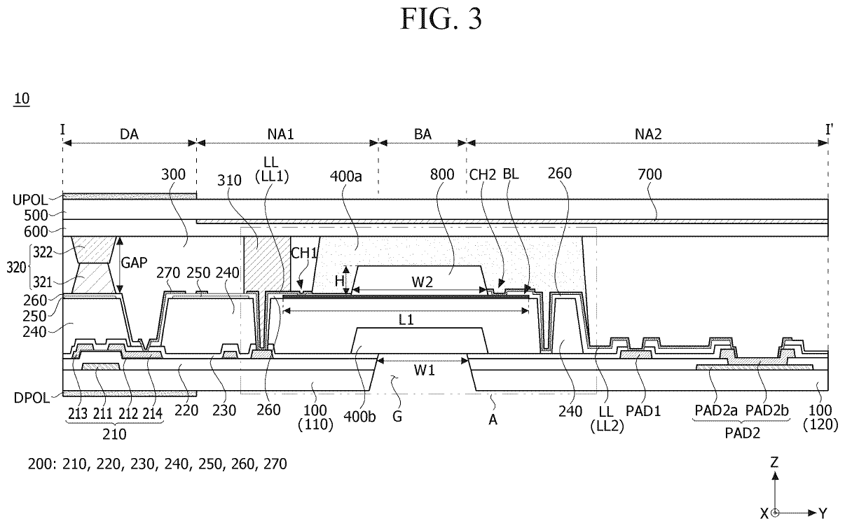

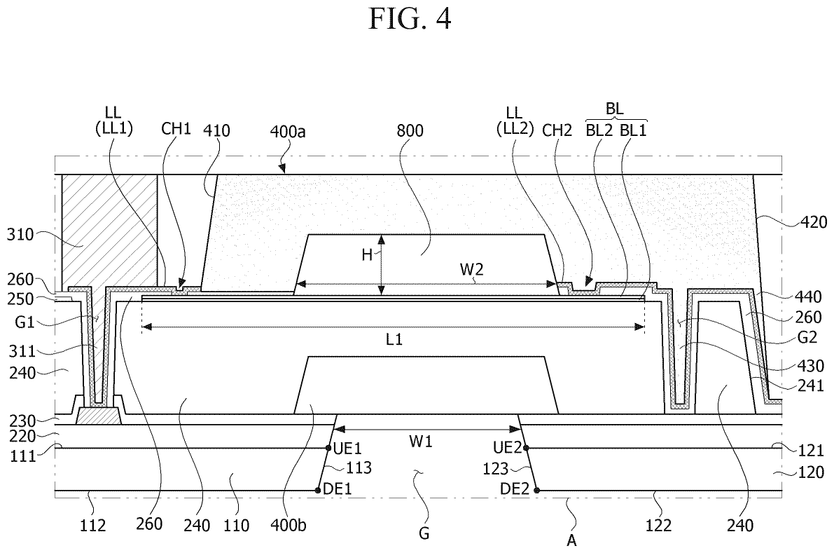

FIG. 1 is a view illustrating a display device according to an example of the present disclosure. FIG. 2 is a plan view illustrating an arrangement relationship among connection wires, bending wires and pad portions in a display panel 10 according to an example of the present disclosure. FIG. 3 is a cross-sectional view taken along line I-I′ in FIG. 2. FIG. 4 is an enlarged view of an area A in FIG. 3.

Referring to FIGS. 1-4, the display device according to one example of the present disclosure may include the display panel 10 including a groove G, a circuit board 20 connected to a pad portion PAD of the display panel 10, and a light source 30 that emits light toward a liquid crystal layer 300 of the display panel 10. In addition, an input image may be visually reproduced on the display panel 10. The light source 30 may be a backlight unit.

The display panel 10 may include a display area DA where an image is displayed and a non-display area NA where no image is displayed. The display panel 10 may be a panel having a rectangular structure having a width in an X-axis direction, a length in a Y-axis direction, and a thickness in a Z-axis direction. In such a case, the width and length of the display panel 10 may be set to various design values depending on the application field of the display device. The X-axis direction may mean a width direction, a row direction, or a horizontal direction, the Y-axis direction may mean a length direction, a column direction, or a vertical direction, and the Z-axis direction may mean an up-down direction, a vertical direction, or a thickness direction. The X-axis direction, the Y-axis direction, and the Z-axis direction may be perpendicular to one another, but may also mean different directions not perpendicular to one another. Therefore, each of the X-axis direction, the Y-axis direction, and the Z-axis direction may be described as any one of a first direction, a second direction, and a third direction. A plane extended in the X-axis direction and the Y-axis direction may mean a horizontal plane.

The non-display area NA may include a first non-display area NA1, a bending area BA, and a second non-display area NA2.

The first non-display area NA1 may be an area surrounding at least a part of the display area DA.

The bending area BA is an area adjacent to at least one side among a plurality of sides of the first non-display area NA1, and may be a bendable area. The display panel 10 may be easily bent through the groove G arranged in the bending area BA.

Referring to FIGS. 2 and 3, the bending area BA is located between the first non-display area NA1 and the second non-display area NA2, and various structures such as organic layers, inorganic layers, and wires arranged in the bending area BA may be bent.

The second non-display area NA2 is an area adjacent to at least one side among a plurality of sides of the bending area BA, and the pad portion PAD may be arranged in the second non-display area NA2. For example, the bending area BA may be in a bent state from a flat state, and the remaining area of a first substrate 100 excluding the bending area BA may be in a flat state. As the bending area BA is bent, the second non-display area NA2 may be located to overlap a back surface of the display area DA. The pad portion PAD may be a pad electrode.

The circuit board 20 may be a flexible printed circuit board and may be connected to the display panel 10 through the pad portion PAD.

The liquid crystal layer 300, etc., of the display area DA may be driven by receiving signals from one or more circuit boards 20 through the wires of the display area DA and a plurality of connection wires LL of the non-display area NA. For example, the wires of the display area DA may be wires for transmitting signals output from the circuit board 20 to the liquid crystal layer 300, etc., of the display area DA together with the plurality of connection wires LL.

When only the plurality of connection wires LL are arranged in the bending area BA, a part of the plurality of connection wires LL may also be bent as the bending area BA is bent. Therefore, stress may be concentrated on a part of the bent connection wires LL, and cracks may occur in the connection wires LL due to the stress.

Therefore, when the plurality of connection wires LL are arranged in the bending area BA, the possibility of damage to the connection wires LL due to cracks, etc. may be considered. For example, in order to prevent or reduce cracks that may occur in the plurality of connection wires LL during the bending of the bending area BA, the connection wire LL may be made of conductive materials having excellent ductility. In addition, the plurality of connection wires LL may be formed in various shapes in order to cope with cracks, etc. For example, at least a part of the plurality of connection wires LL arranged on the bending area BA may have a shape in which conductive patterns having at least one shape among a diamond shape, a rhombus shape, a trapezoidal wave shape, a triangular wave shape, a sawtooth wave shape, a sine wave shape, a circular shape, and an omega (Ω) shape are repeatedly arranged.

The display device according to one example of the present disclosure may stably connect the plurality of connection wires LL and the wires of the display area DA by using the bending wire BL arranged on the bending area BA.

The plurality of connection wires LL may extend from a plurality of pad portions PAD of the second non-display area NA2 toward the bending area BA. The plurality of connection wires LL may be electrically connected to the wires of the display area DA via a plurality of bending wires BL, but are not necessarily limited thereto. For example, in consideration of the stability of connection between the plurality of connection wires LL and the wires of the display area DA, the plurality of connection wires LL may be electrically connected to the wires of the display area DA and the bending wires BL may be arranged to overlap a part of the connection wires LL. Therefore, even though the connection wire LL is damaged by the bending of the display panel 10, signals applied through the connection wires LL may be transmitted to the wires of the display area DA through the bending wire BL.

Accordingly, the possibility of a defect due to the bending of the display panel 10 may be reduced by using the bending wire BL dually arranged on the bending area BA. In such a case, the display panel 10 according to one example of the present disclosure may protect the bending wire BL through a first protective layer 400a and a pattern layer 800 arranged on the bending wire BL. Accordingly, the first protective layer 400a and the pattern layer 800 may further reduce the possibility of defects in the bending wire BL. The connection wire LL may be a link wire. The bending wire BL may be a bending wire.

The light source 30 may be arranged below the first area 110 to emit light toward the first area 110. For example, the light source 30 may emit light in the Z-axis direction. More specifically, the light source 30 may emit light toward the liquid crystal layer 300 arranged above the first area 110. Here, the light source 30 may be a backlight unit.

The display panel 10 may be manufactured based on a flexible plastic material such as polyimide or a flexible glass substrate having a thin thickness. For example, the first substrate 100 of the display panel 10 may be formed of a transparent glass material in consideration of an etching process.

Referring again to FIGS. 1-4, the display panel 10 according to the example of the present disclosure may include a first substrate 100 including the first area 110 and a second area 120 spaced apart from each other by the groove G and arranged adjacent to each other, a circuit layer 200 arranged on the first substrate 100, the liquid crystal layer 300 arranged on the circuit layer 200, the pad portion PAD arranged on the second area 120 for connection with the circuit board 20, the bending wire BL arranged over a planarization layer 240 that extends in the circuit layer 200 over the upper portion of the groove G, a first protective layer 400a arranged over the bending wire BL, and a second substrate 500 arranged over the first protective layer 400a to overlap the first area 110 and the second area 120 of the first substrate 100. Further, the display panel 10 may include a connection wire LL that connects the pad portion PAD and the bending wire BL.

Here, the circuit layer 200 may include a thin film transistor 210, a gate insulating layer 220, a first interlayer dielectric layer 230, the planarization layer 240, a first electrode 250, a second interlayer dielectric layer 260, and a second electrode 270. The thin film transistor 210 may include a gate electrode 211, an active layer 212, a source electrode 213, and a drain electrode 214. In such a case, the planarization layer 240 may extend to a part of the second non-displayed area NA2 through the bending area BA to be arranged over upper portion the groove G. Accordingly, upon etching of the first substrate 100 to form the groove G, the planarization layer 240 may serve as an anti-etching layer, but is not necessarily limited thereto. For example, the display panel 10 according to the example of the present disclosure may further include a second protective layer 400b arranged over the groove G. Here, the planarization layer 240 of the circuit layer 200 may be a first planarization layer or a lower planarization layer.

Furthermore, the display panel 10 according to the example of the present disclosure may further include a planarization layer 600 arranged on the liquid crystal layer 300 and the first protective layer 400a. Here, the planarization layer 600 arranged on the first protective layer 400a may be a second planarization layer, an upper planarization layer, or an envelope layer covering the lower portion of the black matrix 700.

In addition, the display panel 10 according to the example of the present disclosure may further include a sealant 310 surrounding the liquid crystal layer 300, and at least one column 320 arranged between the circuit layer 200 and the planarization layer 600. Here, the sealant 310 may be a sealing member or a seal line.

In addition, the display panel 10 according to the example of the present disclosure may further include a black matrix 700 arranged between the second substrate 500 and the planarization layer 600.

Further, the display panel 10 according to the example of the present disclosure may further include a pattern layer 800 arranged on the bending wire BL. In such a case, the first protective layer 400a may cover the pattern layer 800.

In addition, the display panel 10 according to the example of the present disclosure may further include a lower polarization layer DPOL arranged below the first area 110 and an upper polarization layer UPOL arranged above the second substrate 500.

The first substrate 100 may be made of glass, metal, plastic, or the like, but is not limited thereto. However, the first substrate 100 may use a glass substrate having a predetermined strength for the etching process for process simplification.

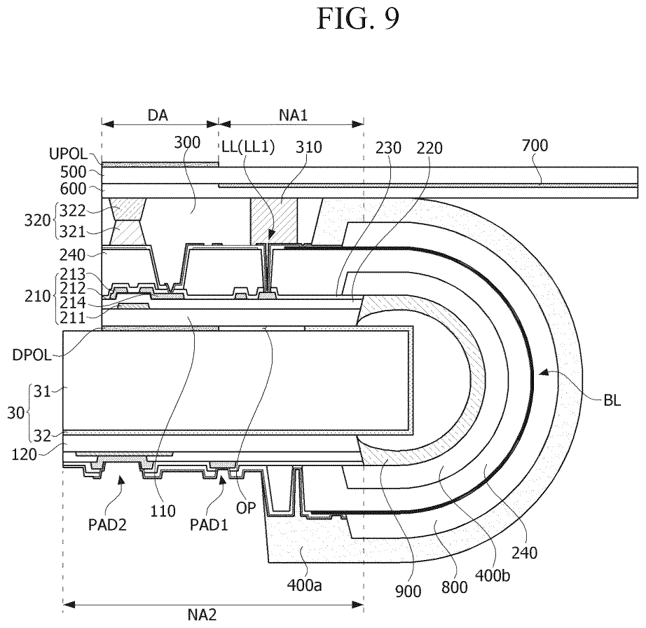

The first substrate 100 may include a first area 110 and a second area 120 separated by the groove G, and the second area 120 may overlap the first area 110 by bending (see FIG. 9). Further, the first area 110 of the first substrate 100 may be arranged in the display area DA and the second area 120 may be arranged in the non-display area NA. Accordingly, the first area 110 may be a display area substrate, and the second area 120 may be a non-display area substrate or a bending substrate.

The groove G may be formed in the first substrate 100, and the first substrate 100 may be divided into a first area 110 and a second area 120 by the groove G.

The groove G may be arranged correspondingly to the bending area BA of the display panel 10.

The groove G may be concavely formed in a lower surface of the first substrate 100. Further, the groove G may be formed in a tapered shape, but is not necessarily limited thereto.

The groove G may be formed in the first substrate 100 through an etching process. In such a case, a plurality of display panels 10 may be manufactured using a single mother substrate including glass, and a cutting process may be performed to the mother substrate after the etching process to separate into each of the plurality of display panels 10.

The plurality of grooves formed in the mother substrate through the etching process may be formed to correspond to the grooves G in each of the plurality of display panels 10. For example, a plurality of grooves may be formed in the mother substrate by etching a portion of the lower surface of the mother substrate using a patterned mask and an etching solution. Accordingly, a process optimization may be implemented by forming a plurality of grooves corresponding to the grooves G of each of the plurality of display panels 10 in the lower surface side of the mother substrate through a single etching process. Here, phosphoric acid (HNO3), hydrofluoric acid (HF), or the like may be used as the etching solution.

When forming the groove G through the etching process, the gate insulating layer 220 and the first interlayer dielectric layer 230 of the circuit layer 200 may be removed together with the mother substrate.

Since the gate insulating layer 220 and the first interlayer dielectric layer 230 are not arranged in the groove G, damage such as cracks due to stress caused by bending does not occur in the gate insulating layer 220 and the first interlayer dielectric layer 230. For example, even though the gate insulating layer 220 and the first interlayer dielectric layer 230 are made of an inorganic insulating material vulnerable to bending, since the gate insulating layer 220 and the first interlayer dielectric layer 230 are not arranged in the bending area BA, the gate insulating layer 220 and the first interlayer dielectric layer 230 are not damaged due to stress caused by bending. In such a case, since the second interlayer dielectric layer 260 made of an inorganic insulating material is also not arranged in the bending area BA, the second interlayer dielectric layer 260 is not damaged due to stress caused by bending.

Furthermore, since the first substrate 100 made of glass is processed by the etching process to form the groove G, a decrease in the rigidity of the glass substrate may be minimized or reduced. Accordingly, the rigidity of the glass substrate may be maintained.

The first area 110 may include the display area DA and the first non-display area NA1, and may be made of a transparent glass material.

The first area 110 may include a first upper surface 111 that contacts the circuit layer 200, a first lower surface 112 that is an opposite surface of the first upper surface 111, and a first side surface 113 that connects the first upper surface 111 and the first lower surface 112. The first area 110 may include a first upper edge UE1 where the first upper surface 111 and the first side surface 113 meet each other, and a first lower edge DE1 where the first lower surface 112 and the first side surface 113 meet each other. The first side surface 113 may be an inclined surface having a predetermined slope with respect to the first lower surface 112. Since the first side surface 113 is formed by the etching process, a curved surface may be formed at the first lower edge DE1 where the first lower surface 112 and the first side surface 113 meet each other.

The second area 120 may be arranged in the second non-display area NA2 and may be made of a transparent glass material.

The second area 120 may include a second upper surface 121 that contacts the gate insulating layer 220, a second lower surface 122 that is an opposite surface of the second upper surface 121, and a second side surface 123 that connects the second upper surface 121 and the second lower surface 122. The second area 120 may include a second upper edge UE2 where the second upper surface 121 and the second side surface 123 meet each other, and a second lower edge DE2 where the second lower surface 122 and the second side surface 123 meet each other. The second side surface 123 may be an inclined surface having a predetermined slope with respect to the second lower surface 122. Since the second side surface 123 is formed by the etching process, a curved surface may be formed at the second lower edge DE2 where the second lower surface 122 and the second side surface 123 meet each other.

The circuit layer 200 may be arranged in the display area DA, and some components of the circuit layer 200 may be arranged in the first non-display area NA1, the bending area BA, and the second non-display area NA2. For example, the circuit layer 200 may be arranged on the first upper surface 111 of the first area 110, and some components of the circuit layer 200 may extend to the second non-display area NA2 through the first non-display area NA1 and the bending area BA. For example, the gate insulating layer 220 and the first interlayer dielectric layer 230 may be arranged in the first non-display area NA1 and the second non-display area NA2. In addition, the planarization layer 240 may be arranged in a part of the first non-display area NA1, the bending area BA, and the second non-display area NA2. In addition, the second interlayer dielectric layer 260 may be arranged in the first non-display area NA1 and the second non-display area NA2.

The circuit layer 200 may include the thin film transistor 210, the gate insulating layer 220 covering the gate electrode 211 of the thin film transistor 210, the first interlayer dielectric layer 230 covering the active layer 212, the source electrode 213, and the drain electrode 214 of the thin film transistor 210, the planarization layer 240 arranged on the first interlayer dielectric layer 230, the first electrode 250 arranged on the planarization layer 240, the second interlayer dielectric layer 260 arranged on the first electrode 250, and the second electrode 270 arranged on the second interlayer dielectric layer 260.

The thin film transistor 210 may include the gate electrode 211, the active layer 212, the source electrode 213, and the drain electrode 214.

The gate electrode 211 may be arranged on the first upper surface 111 of the first area 110.

The gate electrode 211 may be made of a conductive material. For example, the gate electrode 211 may be made of a metal material. For example, the gate electrode 211 may be a single layer or a multilayer made of one of molybdenum (Mo), aluminum (Al), chromium (Cr), gold (Au), titanium (Ti), nickel (Ni), neodymium (Nd), and copper (Cu), or an alloy thereof, but is not limited thereto.

A first pad layer PAD2a of the second pad portion PAD2 may be arranged on the second upper surface 121 of the second area 120.

The first pad layer PAD2a may be made of a conductive material. For example, the first pad layer PAD2a may be made of a metal material. For example, the first pad layer PAD2a may be a single layer or a multilayer made of one of molybdenum (Mo), aluminum (Al), chromium (Cr), gold (Au), titanium (Ti), nickel (Ni), neodymium (Nd), and copper (Cu), or an alloy thereof, but is not limited thereto.

In addition, the first pad layer PAD2a may be formed together with the gate electrode 211 by the same mask process of forming the gate electrode 211.

The gate insulating layer 220 may be arranged on the first substrate 100, and arranged in the display area DA, the first non-display area NA1, and the second non-display area NA2 by being etched by the etching process. For example, the gate insulating layer 220 may be arranged on the first area 110 to cover the gate electrode 211. The gate insulating layer 220 may also be arranged on the second area 120 to cover the first pad layer PAD2a of the second pad portion PAD2.

Since the gate insulating layer 220 may be made of an inorganic insulating material, the gate insulating layer 220 may be etched by the etching process. Therefore, the gate insulating layer 220 may be separated into a gate insulating layer 220 arranged on the first area 110 and a gate insulating layer 220 arranged on the second area 120.

The gate insulating layer 220 may be made of an inorganic insulating material such as silicon oxide (SiOₓ) and silicon nitride (SiNₓ). The gate insulating layer 220 may be a single layer or a multilayer made of an inorganic insulating material, but is not limited thereto.

The active layer 212 may be arranged on the gate insulating layer 220 arranged on the first area 110. In addition, the active layer 212 may overlap the gate electrode 211 in the Z-axis direction.

The active layer 212 may be made of amorphous silicon (a-Si), polycrystalline silicon (poly-Si), an oxide semiconductor, an organic semiconductor, etc., but is not necessarily limited thereto.

The first pad portion PAD1 may be arranged on the gate insulating layer 220 arranged on the second area 120. For example, the first pad portion PAD1 may overlap the second area 120. In addition, the gate insulating layer 220 may be arranged between the second area 120 and the first pad portion PAD1.

The first pad portion PAD1 may be made of a conductive material. For example, the first pad portion PAD1 may be made of a metal material. For example, the first pad portion PAD1 may include a metal such as aluminum (Al), chromium (Cr), copper (Cu), molybdenum (Mo), titanium (Ti), and tungsten (W).

The first pad portion PAD1 may be electrically connected to a chip (not shown) arranged on the first pad portion PAD1. For example, the first pad portion PAD1 may be electrically connected to the chip (not shown) via the connection wire LL arranged on the first pad portion PAD1. The first pad portion PAD1 is connected to the chip (not shown) via the connection wire LL as an example, but is not necessarily limited thereto. For example, the first pad portion PAD1 may also be directly connected to the chip (not shown) without the connection wire LL. The chip may include a driving circuit. The connection wire LL arranged on the first pad portion PAD1 may be a second connection wire LL2.

In addition, the first pad portion PAD1 may be formed together with the source electrode 213 and the drain electrode 214 by the same mask process of forming the source electrode 213 and the drain electrode 214.

The second pad layer PAD2b may be arranged on the gate insulating layer 220 arranged on the second area 120. For example, a part of the second pad layer PAD2b may be arranged on the gate insulating layer 220. In addition, the second pad layer PAD2b may be electrically connected to the first pad layer PAD2a by using a contact hole formed in the gate insulating layer 220. Therefore, the second pad layer PAD2b of the second pad portion PAD2 may be arranged on the first pad layer PAD2a and electrically connected to the first pad layer PAD2a.

The second pad layer PAD2b may be made of a conductive material. For example, the second pad layer PAD2b may be made of a metal material. For example, the second pad layer PAD2b may include a metal such as aluminum (Al), chromium (Cr), copper (Cu), molybdenum (Mo), titanium (Ti), and tungsten (W).

In addition, the second pad layer PAD2b may be formed together with the source electrode 213 and the drain electrode 214 by the same mask process of forming the source electrode 213 and the drain electrode 214.

In addition, the second pad layer PAD2b may be electrically connected to the circuit board 20. For example, the second pad layer PAD2b may be connected to the circuit board 20 via the connection wire LL arranged on the second pad layer PAD2b. The connection wire LL arranged on the second pad layer PAD2b may be the second connection wire LL2.

The source electrode 213 may be arranged on the active layer 212. For example, the source electrode 213 may be located in a different layer from the gate electrode 211. The source electrode 213 may be insulated from the gate electrode 211 by the gate insulating layer 220.

The source electrode 213 may be electrically connected to a source region of the active layer 212, and the source electrode 213 may include an area overlapping the source region of the active layer 212. For example, the source electrode 213 may directly contact the source region of the active layer 212.

The source electrode 213 may include a conductive material. For example, the source electrode 213 may include a metal such as aluminum (Al), chromium (Cr), copper (Cu), molybdenum (Mo), titanium (Ti), and tungsten (W).

The drain electrode 214 may be arranged on the active layer 212. For example, the drain electrode 214 may be located in a different layer from the gate electrode 211. The drain electrode 214 may be insulated from the gate electrode 211 by the gate insulating layer 220. The drain electrode 214 may be arranged in the same layer as the source electrode 213. The drain electrode 214 may be arranged spaced apart from the source electrode 213.

The drain electrode 214 may be electrically connected to a drain region of the active layer 212, and the drain electrode 214 may include an area overlapping the drain region of the active layer 212. For example, the drain electrode 214 may directly contact the drain region of the active layer 212.

The drain electrode 214 may include a conductive material. For example, the drain electrode 214 may include a metal such as aluminum (Al), chromium (Cr), copper (Cu), molybdenum (Mo), titanium (Ti), and tungsten (W).

The first interlayer dielectric layer 230 arranged on the first substrate 100 may be arranged on the display area DA, the first non-display area NA1, and the second non-display area NA2 by being etched first through an etching process. For example, the first interlayer dielectric layer 230 may be arranged on the first area 110 to cover the gate electrode 211, etc. In addition, the first interlayer dielectric layer 230 may be arranged on the second area 120 to cover the first pad portion PAD1 and the second pad layer PAD2b of the second pad portion PAD2.

The first interlayer dielectric layer 230 may be arranged on the active layer 212, the source electrode 213, and the drain electrode 214. In such a case, the first interlayer dielectric layer 230 may cover the active layer 212, the source electrode 213, and the drain electrode 214 on the first area 110. Therefore, the first interlayer dielectric layer 230 may protect the active layer 212, the source electrode 213, and the drain electrode 214.

In addition, the first interlayer dielectric layer 230 may be arranged on the first pad portion PAD1 and the second pad layer PAD2b of the second pad portion PAD2. In such a case, the first interlayer dielectric layer 230 may cover a part of the first pad portion PAD1 and the second pad layer PAD2b on the second area 120.

The first interlayer dielectric layer 230 may be made of an inorganic insulating material such as silicon oxide (SiOₓ) and silicon nitride (SiNₓ). The first interlayer dielectric layer 230 may be a single layer or a multilayer made of an inorganic insulating material, but is not limited thereto.

The planarization layer 240 may be arranged on the first interlayer dielectric layer 230. In such a case, the planarization layer 240 of the circuit layer 200 may extend to a part of the non-display area NA2 through the bending area BA to be arranged on the upper portion of the groove G. Therefore, the planarization layer 240 may overlap the second area 120 in the second non-display area NA2.

The planarization layer 240 made be made of a transparent organic insulating material. For example, the planarization layer 240 made be made of one or more materials among polyacrylates resin, epoxy resin, phenolic resin, polyamides resin, polyimides resin, unsaturated polyesters resin, polyphenylenethers resin, polyphenylene sulfides resin, and benzocyclobutene, but is not limited thereto. The planarization layer 240 may be a single layer or a multilayer made of an organic insulating material.

Since the planarization layer 240 is made of an organic insulating material having relatively excellent ductility compared to an inorganic insulating material, it may easily cope with bending of the display panel 10. For example, since the planarization layer 240 may be arranged in the bending area BA and is made of an organic insulating material with good ductility, the planarization layer 240 may be easily bent without damage such as cracks.

The planarization layer 240 may be arranged on the groove G. For example, since the planarization layer 240 may extend to a part of the second non-display area NA2 through the first non-display area NA1 and the bending area BA, the planarization layer 240 may cover the upper portion of the groove G.

Since the planarization layer 240 may be made of an organic insulating material having strong corrosion resistance to the etching solution, the etching process is no longer performed by the planarization layer 240. That is, the planarization layer 240 may serve as an etch stopper. Accordingly, the groove G may be formed up to the planarization layer 240 by the etching process, and a portion of the lower surface of the planarization layer 240 may be exposed by the groove G.

In the display device according to the example of the present disclosure, when the planarization layer 240 serves as an etch stopper, it is not necessary to arrange a separate second protective layer 400b covering the upper portion of the groove G, which may improve process productivity. Furthermore, when the planarization layer 240 serves as an etch stopper, the bending wire BL arranged over the planarization layer 240 may be protected from the etching solution.

Upon etching of the first substrate 100 to form the groove G, the planarization layer 240 made of an organic insulating material having strong corrosion resistance may serve as an etch stopper, but is not necessarily limited thereto.

The display device according to the example of the present disclosure may further include a second protective layer 400b arranged over the groove G. For example, when arranging the second protective layer 400b over the groove G and covering the second protective layer 400b by the planarization layer 240, the second protective layer 400b may serve as the etch stopper to resist the etching solution.

The second protective layer 400b may be made of a material having corrosion resistant (or chemical resistant) to the etching solution used in the etching process. For example, the second protective layer 400b may include at least one of silicone-based organics, urethane, polyimide, and photoacrylic. Additionally, the second protective layer 400b may include at least one of chromium (Cr), aluminum (Al), platinum (Pt), gold (Ag), and nickel (Ni).

Since the second protective layer 400b may be formed of an organic insulating material having strong corrosion resistance to the etching solution, the etching process is no longer performed by the second protective layer 400b. Accordingly, the groove G may be formed up to the second protective layer 400b by the etching process, and a portion of the lower surface of the second protective layer 400b may be exposed by the groove G.

The second protective layer 400b is intended to protect a configuration located above the second protective layer 400b during the process of forming the groove G in the first substrate 100, and the second protective layer 400b may have a larger size than the area overlapping the groove G, or a larger size (or width) than the bending area BA. For example, based on the Y-axis direction, the width of the second protective layer 400b may be greater than the width W1 of the groove G.

The second protective layer 400b may be formed using a slit coater, inkjet, dispenser, or the like. Additionally, the second protective layer 400b may be formed by a patterning process using a photolithography mask. Here, the second protective layer 400b may be an anti-etching layer, an etch stop pattern, an etch barrier pattern, or an etch mask pattern.

The first electrode 250 may be arranged on the planarization layer 240. The first electrode 250 may be a common electrode.

The first electrode 250 may be made of a transparent conductive material or an opaque conductive material. For example, the first electrode 250 may be made of indium tin oxide (ITO), indium zinc oxide (IZO), or other conductive materials.

A voltage may be applied to the first electrode 250 and the second electrode 270. Therefore, the liquid crystal layer 300 may be driven to display an image. In such a case, a voltage may be applied to the second electrode 270 through the drain electrode 214.

The bending wire BL may be arranged on the planarization layer 240. In such a case, the bending wire BL may be arranged in the first non-display area NA1, the bending area BA, and the second non-display area NA2. For example, the bending wire BL may be arranged on the planarization layer 240 arranged in the first non-display area NA1, the bending area BA, and the second non-display area NA2.

The bending wire BL may be formed to have a predetermined first length L1 in the Y-axis direction. The bending wire BL may overlap the groove G in the Z-axis direction, and the first length L1 of the bending wire BL in the Y-axis direction may be greater than a width W1 of the groove G. The first length L1 of the bending wire BL in the Y-axis direction may be greater than a width W2 of the pattern layer 800. The width W1 of the groove G may be a first width, and the width W2 of the pattern layer 800 may be a second width.

The bending wire BL may be made of a conductive material. For example, the bending wire BL may be made of a metal material. For example, the bending wire BL may be a single layer or a multilayer made of one of indium tin oxide (ITO), indium zinc oxide (IZO), molybdenum (Mo), aluminum (Al), chromium (Cr), gold (Au), titanium (Ti), nickel (Ni), neodymium (Nd), and copper (Cu), or an alloy thereof, but is not limited thereto. For example, the bending wire BL may be formed in a double layer structure.

The bending wire BL may include a first layer BL1 and a second layer BL2. Materials of the first layer BL1 and the second layer BL2 may be different from each other. Therefore, the bending wire BL may easily cope with stress caused by bending.

In the bending wire BL, at least one of the first layer BL1 and the second layer BL2 may include the same metal layer as the first electrode 250.

In addition, the first layer BL1 and the second layer BL2 of the bending wire BL may be made of different materials from the first electrode 250.

The first layer BL1 may be arranged on the planarization layer 240. The first layer BL1 may be made of transparent indium tin oxide (ITO) or indium zinc oxide (IZO). For example, the first layer BL1 may include the same material as the first electrode 250 and may be formed together with the first electrode 250 through the same mask process for forming the first electrode 250.

The second layer BL2 may be arranged on the first layer BL1. The second layer BL2 may have the same length as the first layer BL1 based on the Y-axis direction. For example, the first layer BL1 and the second layer BL2 may be formed to have the predetermined first length L1 in the Y-axis direction.

The second layer BL2 may be made of a different material from the first layer BL1. For example, the second layer BL2 may be made of one of molybdenum (Mo), aluminum (Al), chromium (Cr), gold (Au), titanium (Ti), nickel (Ni), neodymium (Nd), and copper (Cu), or an alloy thereof. For example, the second layer BL2 may include copper (Cu).

In addition, the bending wire BL may include a different material from the material of the connection wire LL. For example, since the connection wire LL may be made of indium tin oxide (ITO) or indium zinc oxide (IZO) and the second layer BL2 of the bending wire BL may be made of copper, the bending wire BL may include a different material from the material of the connection wire LL.

Accordingly, the display device according to one example of the present disclosure may easily cope with stress caused by bending because the first connection wire LL1 and the second connection wire LL2 are connected via the bending wire BL. Moreover, since the bending wire BL includes at least two layers including different materials, it may more effectively cope with stress caused by bending. The first connection wire LL1 may be a first link line, and the second connection wire LL2 may be a second link line.

The second interlayer dielectric layer 260 may be arranged on the first electrode 250 and the bending wire BL. For example, the second interlayer dielectric layer 260 may be arranged on the planarization layer 240 to cover the first electrode 250 and a part of the bending wire BL. In such a case, the second interlayer dielectric layer 260 may be arranged in the display area DA, the first non-display area NA1, and the second non-display area NA2. The second interlayer dielectric layer 260 may be arranged between the bending wire BL and the first connection wire LL1 in the first non-display area NA1 based on the Z-axis direction.

In the second non-display area NA2, the second interlayer dielectric layer 260 may be arranged between the bending wire BL and the second connection wire LL2.

The second interlayer dielectric layer 260 may be made of an inorganic insulating material such as silicon oxide (SiOx) and silicon nitride (SiNx). The second interlayer dielectric layer 260 may be a single layer or a multilayer made of an inorganic insulating material, but is not limited thereto.

The second electrode 270 may be arranged on the second interlayer dielectric layer 260. The second electrode 270 may be electrically connected to the drain electrode 214 through a contact hole formed in the planarization layer 240 and the second interlayer dielectric layer 260. The second electrode 270 may be a pixel electrode.

The second electrode 270 may be made of a transparent conductive material or an opaque conductive material. For example, the second electrode 270 may be made of indium tin oxide (ITO), indium zinc oxide (IZO), or other conductive materials.

The connection wire LL may be arranged on the second interlayer dielectric layer 260. For example, the plurality of connection wires LL may be arranged on the second interlayer dielectric layer 260 to transmit signals applied from the circuit board 20 to the wires of the display area DA. In such a case, the plurality of connection wires LL may be connected to the first pad portion PAD1 and the second pad portion PAD2 through contact holes formed in the first interlayer dielectric layer 230, the planarization layer 240, and the second interlayer dielectric layer 260, or the first and second interlayer dielectric layers 230 and 260.

The connection wire LL may be made of a transparent conductive material or an opaque conductive material. For example, the connection wire LL may be made of indium tin oxide (ITO), indium zinc oxide (IZO), or other conductive materials.

The connection wires LL may be formed together with the second electrode 270 by the same mask process of forming the second electrode 270.

The connection wires LL may include the first connection wire LL1 and the second connection wire LL2 arranged spaced apart from each other. The first connection wire LL1 and the second connection wire LL2 may be electrically connected via the bending wire BL. For example, the pattern layer 800 may be arranged between the first connection wire LL1 and the second connection wire LL2 based on the Y-axis direction. In such a case, the bending wire BL arranged below the pattern layer 800 may be electrically connected to the first connection wire LL1 through a first contact hole CH1 and may be electrically connected to the second connection wire LL2 through a second contact hole CH2. Therefore, the first connection wire LL1 may contact one side of the bending wire BL, and the second connection wire LL2 may contact the other side of the bending wire BL. The first contact hole CH1 may be arranged in the first non-display area NA1. The first contact hole CH1 may be formed to penetrate the second interlayer dielectric layer 260 arranged between the bending wire BL and the first connection wire LL1. The second contact hole CH2 may be arranged in the second non-display area NA2. The second contact hole CH2 may be formed to penetrate the second interlayer dielectric layer 260 arranged between the bending wire BL and the second connection wire LL2.

The first connection wire LL1 may be arranged in the first non-display area NA1. For example, the first connection wire LL1 may be arranged on the second interlayer dielectric layer 260 of the first non-display area NA1. In addition, the first connection wire LL1 may be electrically connected to the bending wire BL through the first contact hole CH1 in the first non-display area NA1.

The second connection wire LL2 may be arranged in the second non-display area NA2. For example, the second connection wire LL2 may be arranged on the second interlayer dielectric layer 260 of the second non-display area NA2. The second connection wire LL2 may be electrically connected to the bending wire BL through the second contact hole CH2 in the second non-display area NA2.

The liquid crystal layer 300 may be arranged on the second interlayer dielectric layer 260, the second electrode 270, and the first connection wire LL1, and may include an alignment film (not shown) for easily inducing the arrangement of liquid crystals.

The sealant 310 may be a photocurable or thermocurable epoxy resin and may surround the liquid crystal layer 300. For example, the sealant 310 may be arranged along the perimeter of the liquid crystal layer 300 to seal the liquid crystal layer 300. Accordingly, the sealant 310 may be a sealing member or a seal line.

Additionally, the sealant 310 may be a member used to bond the first substrate 100 and the second substrate 500.

Referring to FIGS. 3 and 4, the sealant 310 may be arranged over the second interlayer dielectric layer 260 or on the first connection wire LL1.

Further, based on the Z-axis direction, the sealant 310 may be arranged between the second interlayer dielectric layer 260 and the planarization layer 600. Also, based on the Z-axis direction, the sealant 310 may be arranged between the first connection wire LL1 and the planarization layer 600.

Additionally, the sealant 310 may overlap the planarization layer 240 in the first non-display area NA1.

Referring to FIG. 4, a portion of the sealant 310 may be arranged in the inside of a groove G1 concavely formed in the upper surface of the planarization layer 240. Accordingly, a portion of the sealant 310 may overlap the planarization layer 240 in a horizontal direction. In such a case, a portion of the first connection wire LL1 may be arranged in the inside of the groove G1 formed in the planarization layer 240. The groove G1 of the planarization layer 240 may be a first groove or an inner groove. Here, the term “inner” may refer to the direction toward the center of the display area DA, and the term “outer” may refer to the direction opposite to the inner. And, the portion of the sealant 310 arranged in the inside of the groove G1 may be a protrusion 311 or first protrusion of the sealant 310.

Since a portion of the sealant 310 may be arranged in the inside of the groove G1 formed in the planarization layer 240, the groove G1 of the planarization layer 240 may serve as a guide for the sealant 310 to be positioned in a predetermined location. Furthermore, since the groove G1 formed in the planarization layer 240 may increase the distance of the penetration path for moisture, debris, or the like to enter the display area DA, thereby effectively preventing or reducing moisture, debris, or the like from entering the display area DA.

Referring to FIG. 3, the at least one column 320 may be arranged on the second interlayer dielectric layer 260, but is not necessarily limited thereto. For example, the column 320 may be arranged between the second interlayer dielectric layer 260 and the planarization layer 600 based on the Z-axis direction. Therefore, the column 320 may maintain the gap for injecting liquid crystal.

The column 320 may include a first column part 321 and a second column part 322 which may be formed of an organic insulating material.

The first column part 321 may be arranged on the second interlayer dielectric layer 260 and may be formed together with the pattern layer 800 by the same masking process that forms the pattern layer 800.

The second column part 322 may be arranged on the first column part 321 and may overlap the first column part 321.

The first protective layer 400a may be arranged to overlap the planarization layer 240. For example, the first protective layer 400a may be arranged over the planarization layer 240 and may cover the bending wire BL. Accordingly, the first protective layer 400a may protect the bending wire BL from physical and/or chemical impacts. For example, the first protective layer 400a may prevent or reduce moisture, debris, or the like from penetrating into the bending wire BL. Here, the first protective layer 400a may be a upper micro-coating layer, a upper coating layer, or a first coating layer. Further, the first protective layer 400a may cover a portion of the connection wire LL. Accordingly, the first protective layer 400a may protect a portion of the connection wire LL from physical and/or chemical impacts.

The first protective layer 400a may be arranged across the bending area BA, and as the bending area BA is bent, the first protective layer 400a may also be bent with it. And, the first protective layer 400a may overlap the groove G of the first substrate 100.

The first protective layer 400a may be positioned between the sealant 310 and the first pad portion PAD1 based on the Y-axis direction. In such a case, the first side surface 410, which constitutes one side of the first protective layer 400a, may be spaced apart from the sealant 310. Additionally, the second side surface 420, which constitutes the other side of the first protective layer 400a, may be spaced apart from the first pad portion PAD1. Here, the first side surface 410 may be an inner side surface of the first protective layer 400a, and the second side surface 420 may be an outer side surface of the first protective layer 400a.

A portion of the first protective layer 400a may be arranged in the inside of a groove G2 concavely formed in the upper surface of the planarization layer 240. Accordingly, a portion of the first protective layer 400a may overlap the planarization layer 240 in a horizontal direction. In such a case, a portion of the second connection wire LL2 may also be arranged in the inside of the groove G2 formed in the planarization layer 240, but is not necessarily limited thereto. For example, the grooves G2 formed in the planarization layer 240 may be spaced apart from each other along the X-axis direction, so that the second connection wire LL2 may be arranged between the grooves G2. For example, the grooves G2 of the planarization layer 240 may be a second groove or an outer groove. And, the portion of the first protective layer 400a arranged in the inside of the groove G2 may be a protrusion 430 or a second protrusion of the first protective layer 400a.

The first protective layer 400a may implement a reinforced structure with a portion of the first protective layer 400a arranged in the inside of the groove G2 formed in the planarization layer 240. For example, a portion of the first protective layer 400a may be arranged in the groove G2 of the planarization layer 240 that is arranged adjacent to the bending area BA, so that even if stress caused by bending are applied to the first protective layer 400a, the portion of the first protective layer 400a arranged in the groove G2 may be supported by the planarization layer 240. Accordingly, the first protective layer 400a may cope with stress caused by bending through the portion of the first protective layer 400a arranged in the groove G2. For example, with a portion of the first protective layer 400a arranged in the inside of the groove G2, the first protective layer 400a may improve its resistance to deformation caused by bending.

The first protective layer 400a may be formed of an organic insulating material to copes with stress caused by bending. For example, the first protective layer 400a may be formed of an organic material including an acrylic-based material such as an acrylate polymer, or the like, but not necessarily limited thereto.

The first protective layer 400a may be formed by a manufacturing method using an inkjet, dispenser, screen printer, or the like. For example, when the first protective layer 400a is formed by a method using a dispenser, a portion of the first protective layer 400a may be located between the planarization layer 240 and the first pad portion PAD1. For example, if the material used in the manufacturing method using a dispenser has a low viscosity, a portion of the first protective layer 400a may cover some or all of the side surface 241 of the planarization layer 240 in the second non-display area NA2. For example, a portion of the first protective layer 400a may be arranged to contact the second interlayer dielectric layer 260 covering the side surface 241 of the planarization layer 240 in the second non-display area NA2, or may cover the second interlayer dielectric layer 260.

Accordingly, the second side surface 420 of the first protective layer 400a may be arranged closer to the first pad portion PAD1 than the planarization layer 240. That is, based on the Y-axis direction, a portion of the first protective layer 400a may be arranged between the planarization layer 240 and the pad portion PAD. Here, the portion of the first protective layer 400a arranged between the planarization layer 240 and the pad portion PAD based on the Y-axis direction may be a protrusion 440 or a third protrusion of the first protective layer 400a. In such a case, the first protective layer 400a may include at least two protrusions 430 and 440 arranged to be spaced apart from each other, and thus the second protrusion may be referred to as an inner protrusion and the third protrusion may be referred to as an outer protrusion.

The second substrate 500 may overlap the first area 110 and the second area 120 of the first substrate 100. For example, the second substrate 500 may be formed of the same size or a similar size as the first substrate 100, but is not necessarily limited thereto. For example, the second substrate 500 may be formed at a smaller size than the first substrate 100, and may be formed to have a size that may cover the bending area BA. That is, the second substrate 500 may overlap the bending area BA in the Z-axis direction.

The second substrate 500 may be arranged over the planarization layer 600 and the black matrix 700. Accordingly, the second substrate 500 may protect the planarization layer 600 and the black matrix 700. Additionally, the second substrate 500 may protect a configuration arranged below the planarization layer 600 and the black matrix 700.

An end of the second substrate 500 may protrude further than the black matrix 700 in the Y-axis direction, but is not necessarily limited thereto. For example, an end of the second substrate 500 may be arranged to overlap an end of the black matrix 700 in the Z-axis direction.

The second substrate 500 may be made of a transparent plastic material, a glass material, or a reinforced glass material.

Additionally, the second substrate 500 may include color filters or may include a separate liquid crystal layer (not shown). Here, the color filter layer may include red, green, and blue color filters. For example, the color filter layer may include an acrylic resin and a pigment. The color filter layer may be classified into red, green, and blue depending on the type of pigment that implements a color.

The planarization layer 600 is arranged on the liquid crystal layer 300 and the first protective layer 400a, so that it may protect the liquid crystal layer 300 and the first protective layer 400a, and may be provided for surface planarization. Here, the planarization layer 600 may be an overcoat layer.

Additionally, the planarization layer 600 may be arranged under a lower portion of the second substrate 500 and may be in contact with the first protective layer 400a. For example, the planarization layer 600 may be arranged on the first protective layer 400a. When the second substrate 500 is bonded to the first substrate 100 using the sealant 310, the planarization layer 600 may be supported by the first protective layer 400a.

The planarization layer 600 may be made of an organic material such as photo acryl, benzocyclobutene, polyimide, fluorinated resin, or the like.

The black matrix 700 may be arranged between the second substrate 500 and the planarization layer 600. In such a case, the black matrix 700 may be arranged in the non-display area NA and may overlap a portion of the liquid crystal layer 300 and the sealant 310.

In addition, the black matrix 700 may have a closed loop shape surrounding the display area DA. Therefore, the black matrix 700 may prevent or reduce light leakage.

The display panel 10 according to the present disclosure may further include a pattern layer 800 arranged over the planarization layer 240.

The pattern layer 800 may be arranged on the bending wire BL. Therefore, the pattern layer 800 may protect the bending wires BL from physical and/or chemical impact. For example, the pattern layer 800 may prevent or reduce moisture, impurities, or the like, from penetrating into the bending wires BL.

The pattern layer 800 may be arranged in the bending area BA, and as the bending area BA is bent, the pattern layer 800 may also be bent with it. And, the pattern layer 800 may overlap the groove G.

The pattern layer 800 may be made of an organic insulating material in order to cope with stress caused by bending. For example, the pattern layer 800 may be made of an organic material including a polyester-based polymer, an acrylic-based polymer, or the like.

The pattern layer 800 may be provided as a structure having predetermined width W2 and height H, and may be arranged along the X-axis direction. For example, the pattern layer 800 may be formed in a bar shape including a trapezoidal cross-section.

The pattern layer 800 may be formed to have the predetermined width W2, and the width W2 of the pattern layer 800 may be larger than the width W1 of the groove G, but is not necessarily limited thereto. For example, the width W2 of the pattern layer 800 may be the same as the width W1 of the groove G. In addition, the width W2 of the pattern layer 800 may be smaller than the first length L1 of the bending wire BL.

The pattern layer 800 may be formed to have the predetermined height H. The height H of the pattern layer 800 may be adjusted. Therefore, the display panel 10 according to one example of the present disclosure may minimize or reduce stress applied to the bending wire BL by adjusting the height H of the pattern layer 800.

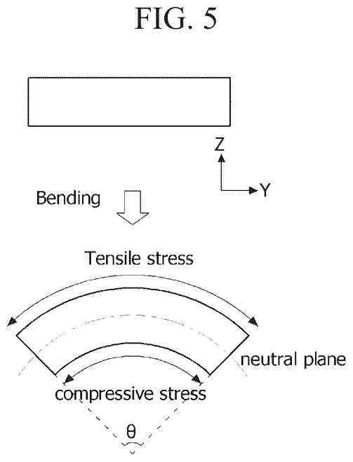

FIG. 5 is a view illustrating the neutral plane according to bending.

Referring to FIG. 5, the neutral plane may be defined as a plane where a stress state is zero during bending, and the size of tensile stress or compressive stress is determined in proportion to a distance from the neutral plane. The neutral plane may be located in the center between a plane where the tensile stress is applied and a plane where the compressive stress is applied, based on the Z direction. The plane where the compressive stress is applied may be defined as a plane arranged close to the center of curvature, and the plane where the tensile stress is applied may be defined as an opposite plane of the plane where the compressive stress is applied.

In addition, cracks are more likely to occur in a configuration arranged in an area where the tensile stress is applied than in a configuration arranged in an area where the compressive stress is applied. For example, since the bending wire BL arranged in the bending area BA of the display panel 10 may be arranged in an area where the tensile stress is applied, there is a relatively high probability that cracks will occur in the bending wire BL due to bending of the bending area BA. Therefore, since cracks are more likely to occur in an area subject to the tensile stress than in an area subject to the compressive stress during bending, the stress applied to the bending wire BL may be minimized or reduced by moving the neutral plane to be closer to the bending wire BL.

Accordingly, when the pattern layer 800 is arranged on the bending wire BL (see FIG. 4), the display device according to one example of the present disclosure may position the neutral plane on the bending wire BL or move the neutral plane to be closer to the bending wire BL by adjusting the height H of the pattern layer 800 in a state where the thickness from the first substrate 100 to the first protective layer 400a is determined. Therefore, the display panel 10 may reduce stress applied to the bending wire BL during the bending of the display panel 10 by using the pattern layer 800.

The display device according to the present disclosure may further include an upper polarization layer UPOL and a lower polarization layer DPOL arranged on the bending wire BL.

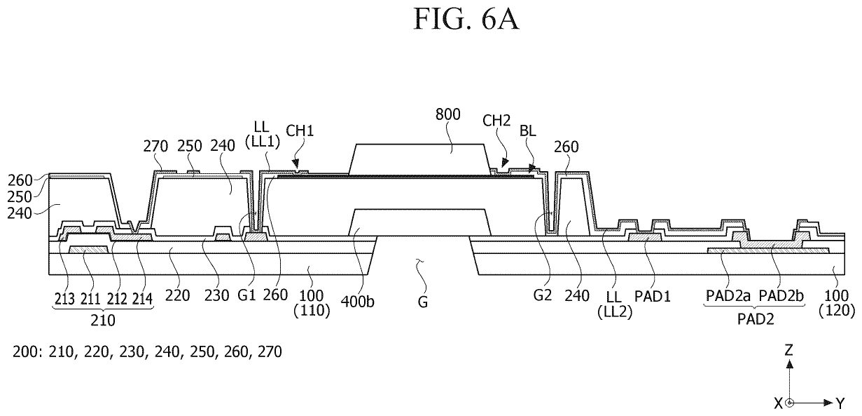

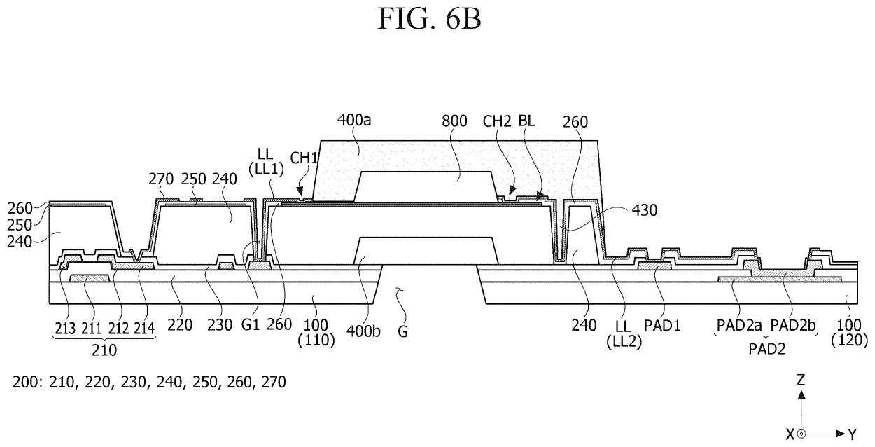

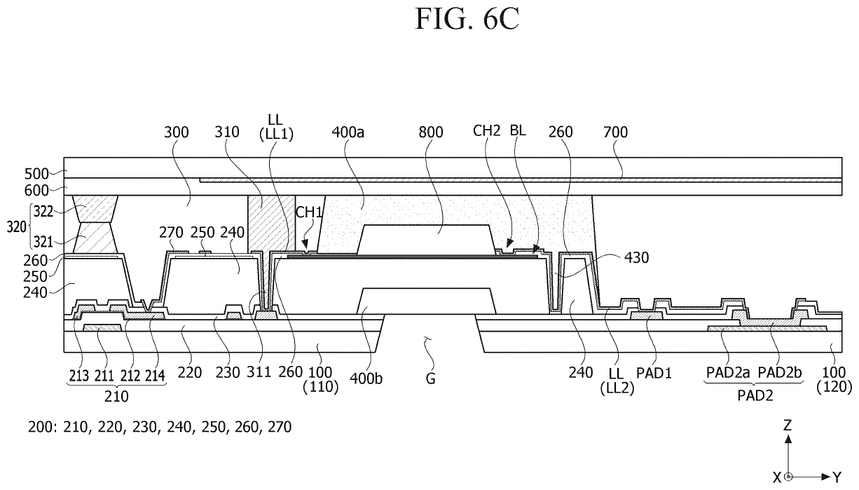

FIGS. 6A-6C are views illustrating a manufacturing process of the display panel 10 according to the example of the present disclosure.

Referring to FIG. 6A, the second protective layer 400b, the circuit layer 200, the bending wire BL, the pattern layer 800, the connection wire LL, and the like may be arranged above the first substrate 100, and the grooves G may be formed using an etching process. Further, the first groove G1 and the second groove G2 may be formed in the planarization layer 240.

Referring to FIG. 6B, the first protective layer 400a may be arranged over the pattern layer 800. The first protective layer 400a may be formed by a manufacturing method using an inkjet, a dispenser, or the like. Accordingly, a portion of the first protective layer 400a may cover some or all of the side surface 241 of the planarization layer 240 in the second non-display area NA2. In such a case, a portion of the first protective layer 400a may be arranged in the second groove G2 of the planarization layer 240.

Considering the manufacturing tolerances of the first protective layer 400a according to the method using the dispenser, the possibility of interference of the first protective layer 400a according to the post-process placement of the sealant 310, or the like, the first side surface 410 of the first protective layer 400a may be arranged over the pattern layer 800 so as to be spaced apart from the sealant 310. Accordingly, the sealant 310 may be spaced apart from the first side surface 410 of the first protective layer 400a. As an example, the sealant 310 is arranged spaced apart from the first side surface 410 of the first protective layer 400a, but is not necessarily limited thereto. For example, if the sealant 310 is not damaged by the bending of the first protective layer 400a even when the first protective layer 400a is bent, the first protective layer 400a may be arranged in contact with the sealant 310. For example, if the first protective layer 400a is cured while in contact with the sealant 310, stress caused by bending of the display panel 10 are likely to be transmitted to the sealant 310. And, since stress caused by bending of the first protective layer 400a may be transmitted to the sealant 310 and cause deformation of the sealant 310, the spaced arrangement between the sealant 310 and the first protective layer 400a may prevent or reduce stress caused by bending of the first protective layer 400a from being transmitted to the sealant 310 in advance.

Referring to FIG. 6C, the first substrate 100 and the second substrate 500 may be bonded together using the sealant 310. In such a case, the first protective layer 400a may support the second substrate 500, and the liquid crystal layer 300 may be arranged between the first substrate 100 and the second substrate 500. In such a case, a portion of the sealant 310 may be arranged in the first groove G1 of the planarization layer 240.

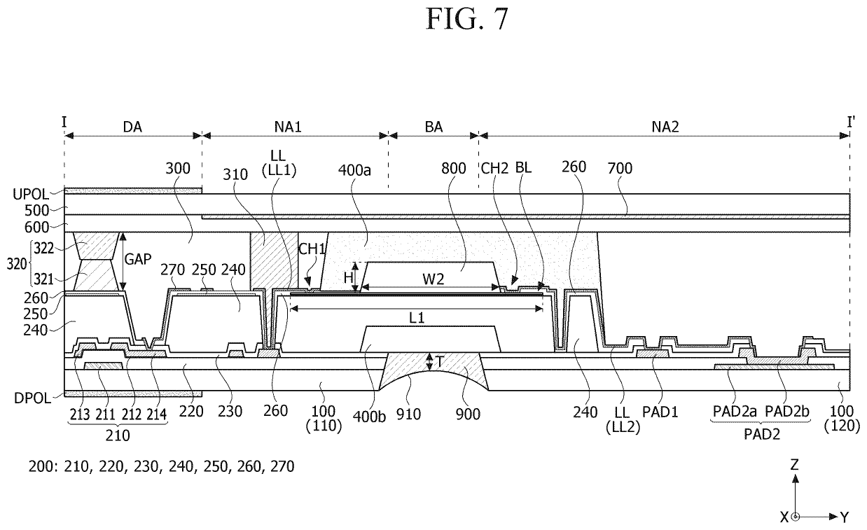

FIG. 7 is a view illustrating a coating layer 900 arranged in the display panel 10 according to the example of the present disclosure.

Referring to FIG. 7, the display panel 10 according to the example of the present disclosure may further include the coating layer 900 arranged in the groove G. Here, the coating layer 900 arranged in the groove G may be a lower micro-coating layer, a lower coating layer, or a second coating layer.

The coating layer 900 may be arranged below the second protective layer 400b to overlap a portion of the bending wire BL. Here, the lower surface 910 of the coating layer 900 may be concavely formed toward the planarization layer 240, but is not necessarily limited thereto. For example, the lower surface 910 of the coating layer 900 may also be substantially flat.

The coating layer 900 may be made of an organic material including a polyester-based polymer or an acrylic-based polymer.

The coating layer 900 may be formed to have a predetermined thickness T in consideration of the position of the neutral plane.

The display device according to the example of the present disclosure may adjust the thickness T of the coating layer 900 in a state where the thickness from the second protective layer 400b to the bending wire BL or from the second protective layer 400b to the first protective layer 400a is determined. Therefore, the position of the neutral plane may be on the bending wire BL or moved close to the bending wire BL. Accordingly, the display panel 10 may reduce stress applied to the bending wire BL during the bending of the display panel 10 by using the coating layer 900.

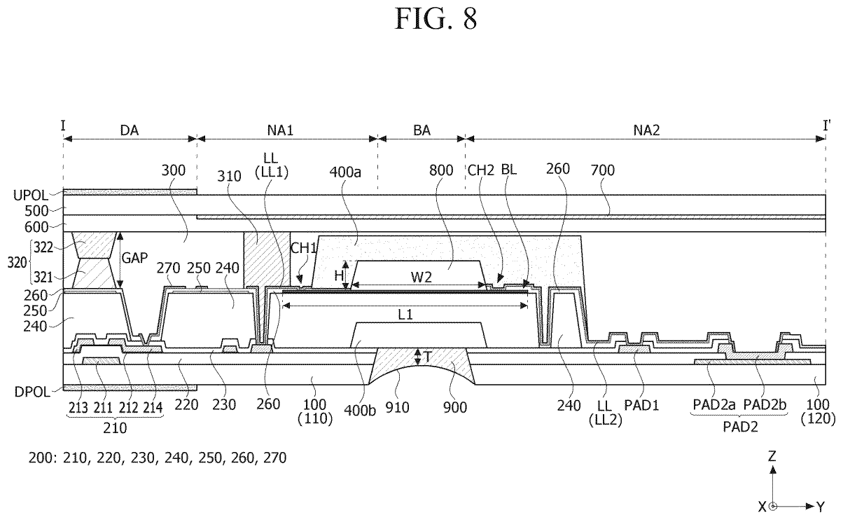

FIG. 8 is a view illustrating the arrangement relationship between a first protective layer 400a and a planarization layer 600 arranged in a display panel according to another example of the present disclosure.

Referring to FIG. 8, the first protective layer 400a may be arranged to be spaced apart from the planarization layer 600. For example, since the process requires that a gap for liquid crystal injection between the second interlayer dielectric layer 260 and the planarization layer 600 be formed to a predetermined size, the thickness in the Z-axis direction of the first protective layer 400a may be formed to be the same as or smaller than the thickness in the Z-axis direction of the sealant 310 in consideration of the size of the gap and the process error that may occur in forming the first protective layer 400a. Accordingly, as shown in FIG. 8, the first protective layer 400a may be arranged to be spaced apart from the planarization layer 600.

FIG. 9 is a view illustrating a bent appearance of the display device according to the example of the present disclosure.

Referring to FIG. 9, the display panel 10 of the display device according to the example of the present disclosure may be bent. For example, as the bending area BA is bent, the display panel 10 may be bent so that the first area 110 and the second area 120 face each other. In such a case, the bending area BA may be bent to have a predetermined radius of curvature. Further, a portion of the first protective layer 400a may be bent in contact with the planarization layer 600.

Since the gate insulating layer 220, the first interlayer dielectric layer 230, and the second interlayer dielectric layer 260 made of an inorganic insulating material are not arranged in the bending area BA of the display panel 10 according to the example of the present disclosure, damage to the gate insulating layer 220, the first interlayer dielectric layer 230, and the second interlayer dielectric layer 260 due to bending may be prevented or reduced in advance.

As the bending area BA is bent, a light source 30 may be arranged between the first area 110 and the second area 120. Here, the light source 30 may emit light toward the first area 110. Accordingly, the light source 30 may overlap the first area 110 in the Z-axis direction.

The light source 30 may include a backlight unit 31 and a backlight unit case 32 surrounding the backlight unit 31. Here, the light source 30 may be a light source module.

The backlight unit 31 may emit light toward the first area 110. The light source used in the backlight unit 31 may use a light emitting diode (LED), but is not necessarily limited thereto.

The backlight unit case 32 may be arranged to surround the backlight unit 31 to protect the backlight unit 31. Further, the backlight unit case 32 may include an opening OP through which light from the backlight unit 31 is emitted toward the first area 110.

The opening OP may be arranged toward the first area 110. In addition, the lower polarization layer DPOL may be arranged in the opening OP.

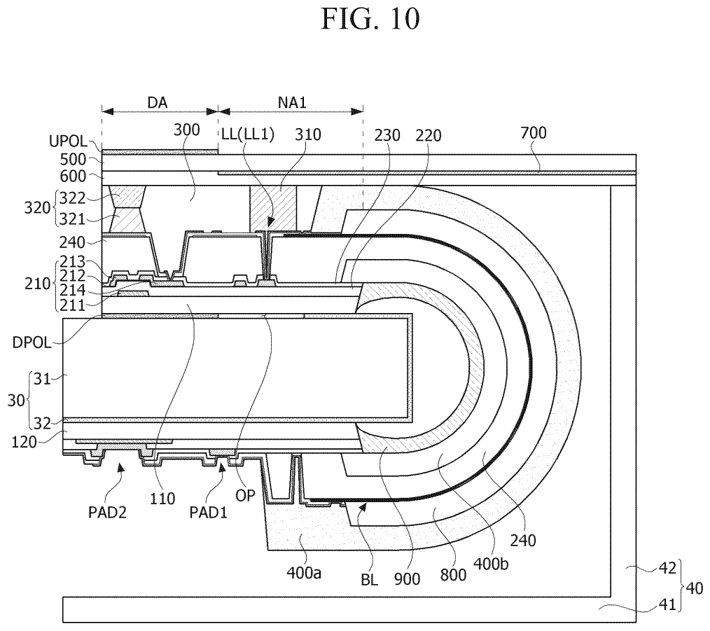

FIG. 10 is a view illustrating a case of the display device according to the example of the present disclosure.

Referring now to FIG. 10, a display device according to the example of the present disclosure may include a case 40. Here, the case 40 may be a cover unit, a bottom cover, or a back cover.

The case 40 may be arranged at the backside of the display panel 10 to protect and support the display panel 10. For example, the case 40 may be formed of a metallic material having high stiffness, but is not necessarily limited thereto. For example, the case 40 may be formed of aluminum (Al), stainless steel, electrolytic galvanized iron (EGI) which is primarily iron (Fe), or the like.

The case 40 may include a bottom part 41 and a sidewall part 42 extending from an edge of the bottom part 41. An end of the sidewall part 42 may contact the lower portion of the second substrate 500. For example, an end of the sidewall part 42 may contact a planarization layer 600 arranged below the second substrate 500.

Accordingly, the display device according to the example of the present disclosure may be implemented as a borderless type in which the case 40 is not visible from the front side, as only the second substrate 500 is exposed on the front side while the pad portion PAD is placed at the backside of the display area DA during bending of the bending area BA.

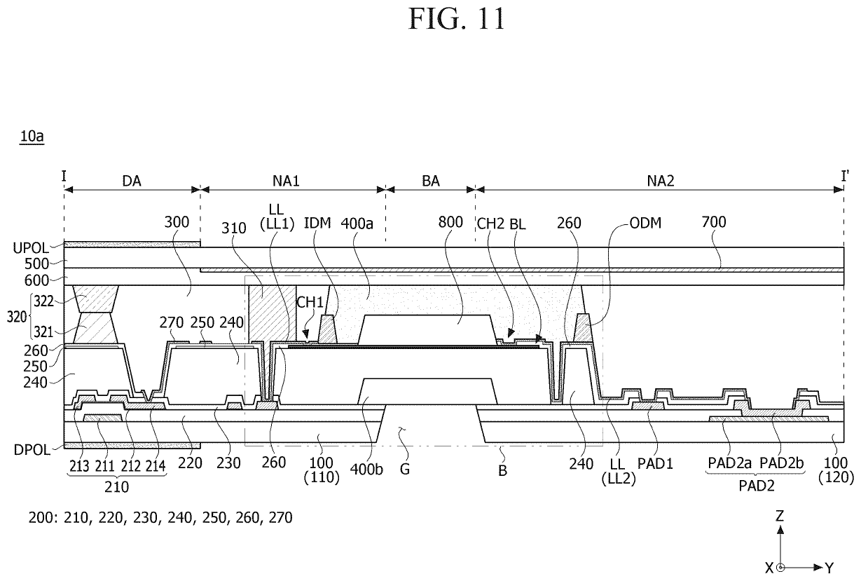

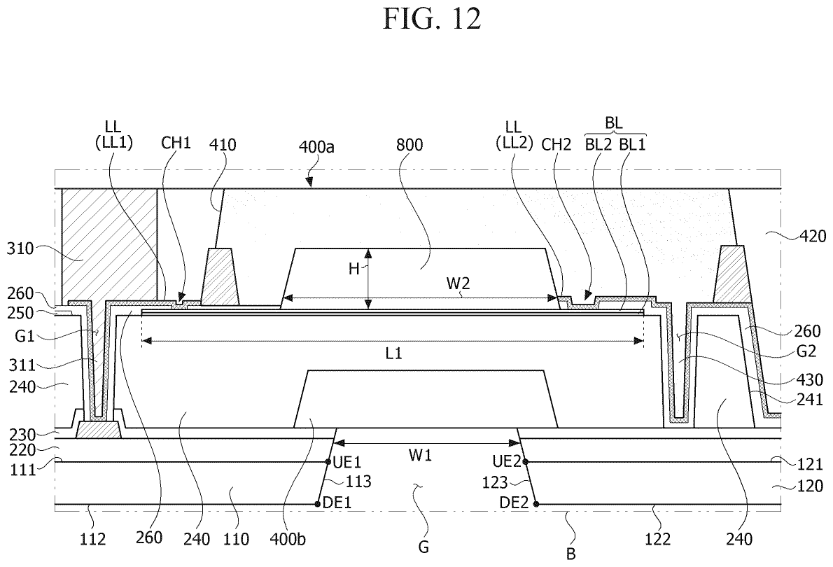

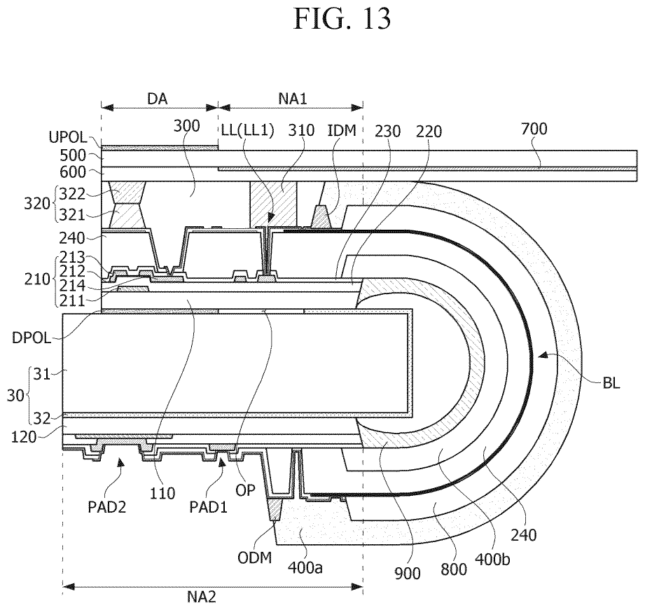

FIG. 11 is a cross-sectional view illustrating a display panel 10a according to another example of the present disclosure. FIG. 12 is an enlarged view of an area B in FIG. 11. FIG. 13 is a view illustrating a bent appearance of a display device to which another example of the display panel 10a according to the example of the present disclosure is applied. The display panel 10a shown in FIGS. 11-13 may be the display panel according to a second example. The display panel 10 shown in FIGS. 3, 4, 6A, and 8 may be the display panel according to a first example.

Comparing the display panel 10 according to the first example with the display panel 10a according to the second example, the display panel 10a according to the second example may further include dams IDM and ODM arranged to be spaced apart from each other with the first protective layer 400a interposed therebetween. Accordingly, during the manufacturing process of the first protective layer 400a, the display panel 10a according to the second example may use the dams IDM and ODM to prevent or reduce overflow of the material forming the first protective layer 400a. In such a case, the display panel 10a according to the second example may be applied to the display device according to the example of the present disclosure instead of the display panel 10 according to the first example.

Referring to FIGS. 11-13, the display panel 10a according to the second example may include a first substrate 100 including a groove G, a circuit layer 200, a liquid crystal layer 300, a sealant 310, a pad portion PAD, a bending wire BL, a first protective layer 400a, a second substrate 500, a connection wire LL, a planarization layer 600, a black matrix 700, a pattern layer 800, a coating layer 900, and the like.

The first substrate 100 including the groove G, the circuit layer 200, the liquid crystal layer 300, the sealant 310, the pad portion PAD, a bending wire BL, the first protective layer 400a, the second substrate 500, the connection wire LL, the planarization layer 600, the black matrix 700, the pattern layer 800, and the coating layer 900 are substantially the same as those of the display panel 10 according to the first example, so the same reference numerals are given to them, and redundant descriptions thereof may be omitted or simplified.

The display panel 10a according to the second example may further include at least two dams IDM and ODM spaced apart from each other with the first protective layer 400a interposed therebetween.

During the manufacturing process of the first protective layer 400a, the display panel 10a according to the second example may use the dams IDM and ODM to prevent or reduce overflow of the first protective layer 400a. For example, when the first protective layer 400a is formed by a method using a dispenser, the dams IDM and ODM may prevent or reduce overflow of the first protective layer 400a. Thus, when the first protective layer 400a is formed using a material with a low viscosity by a method using the dispenser, the dams IDM and ODM may prevent or reduce the material forming the first protective layer 400a from flowing and covering the first pad portion PAD1. As a result, in the display panel 10a according to the second example, a portion of the first protective layer 400a may not cover the side surface 241 of the planarization layer 240.

Referring to FIGS. 11-13, the display panel 10a according to the second example may include an inner dam IDM and an outer dam ODM that are arranged to be spaced apart from each other in the Y-axis direction. In such a case, the inner dam IDM may be arranged at an inner side of the first protective layer 400a and the outer dam ODM may be arranged at an outer side of the first protective layer 400a. For example, the inner dam IDM may be arranged in the first non-display area NA1 to overlap the first area 110. Additionally, the outer dam ODM may be arranged in the second non-display area NA2 to overlap the second area 120.

The inner dam IDM and the outer dam ODM may be arranged over the planarization layer 240. Here, the inner dam IDM may be a first dam and the outer dam ODM may be a second dam.

The inner dam IDM and outer dam ODM may be formed of an organic insulating material, and may be formed together with the pattern layer 800 by the same mask process of forming the pattern layer 800.

The IDM may be arranged in the first non-display area NA1. In such a case, the IDM may be arranged over the planarization layer 240. For example, the IDM may be arranged on a second interlayer dielectric layer 260 that is arranged on the planarization layer 240.

The second connection wire LL2 may be arranged in the second non-display area NA2. In such a case, the outer dam ODM may be arranged over the planarization layer 240. For example, the outer dam ODM may be arranged on a second connecting wire LL2 that is arranged over the planarization layer 240.

Referring to FIG. 13, the display panel 10a according to the second example may be bent. For example, as the bending area BA is bent to have a predetermined radius of curvature, the display panel 10 may be bent so that the first area 110 and the second area 120 face each other. In such a case, the inner dam IDM and outer dam ODM may overlap in the Z-axis direction, but are not necessarily limited thereto.

Since the gate insulating layer 220, the first interlayer dielectric layer 230, and the second interlayer dielectric layer 260 made of an inorganic insulating material are not arranged in the bending area BA of the display panel 10a according to the second example of the present disclosure, damage to the gate insulating layer 220, the first interlayer dielectric layer 230, and the second interlayer dielectric layer 260 due to bending may be prevented or reduced in advance.

As the bending area BA is bent, a light source 30 may be arranged between the first area 110 and the second area 120. Here, the light source 30 may emit light toward the first area 110. Accordingly, the light source 30 may overlap the first area 110 in the Z-axis direction.

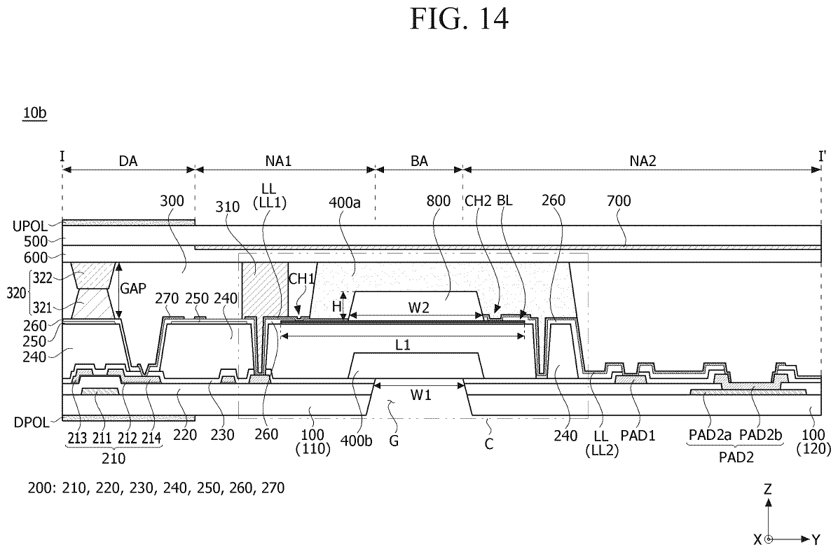

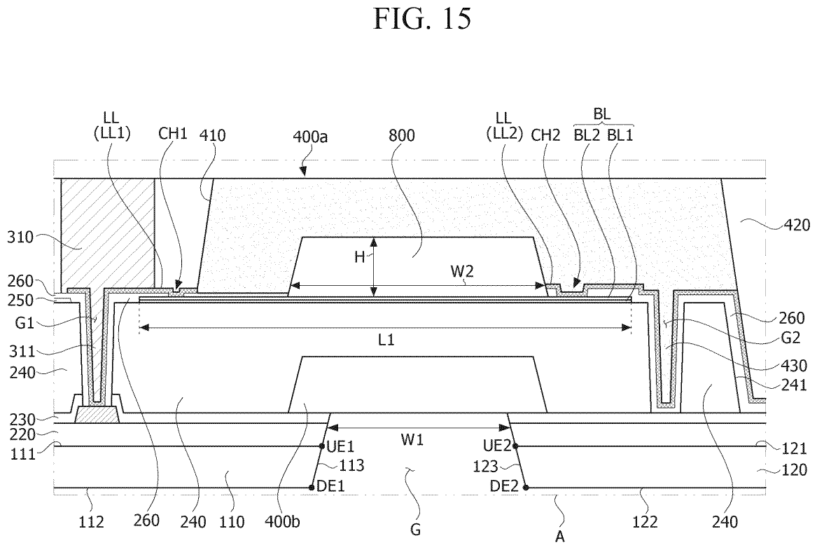

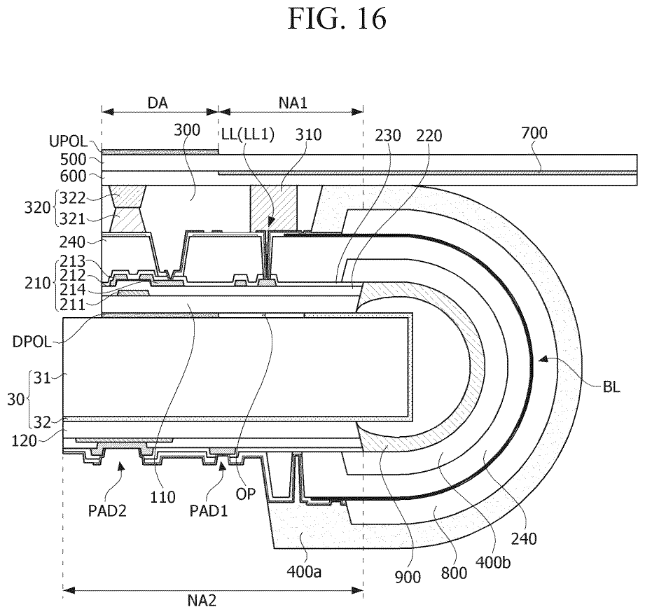

FIG. 14 is a cross-sectional view illustrating a display panel 10b according to another example of the present disclosure. FIG. 15 is an enlarged view of an area C in FIG. 14. FIG. 16 is a view illustrating a bent appearance of a display device to which another example of the display panel 10b according to the example of the present disclosure is applied. The display panel 10b shown in FIGS. 14-16 may be the display panel according to a third example.

Comparing the display panel 10 according to the first example with the display panel 10b according to the third example, in the display panel 10b according to the third example, the first protective layer 400a may be formed by a patterning process using a photolithography mask so that a portion of the first protective layer 400a may not cover the side surface 241 of the planarization layer 240 in the second non-display area NA2. In such a case, the display panel 10b according to the third example may be applied to the display device according to the example of the present disclosure instead of the display panel 10 according to the first example.

Referring to FIGS. 14-16, the display panel 10b according to the third example may include a first substrate 100 including a groove G, a circuit layer 200, a liquid crystal layer 300, a sealant 310, a pad portion PAD, a bending wire BL, a first protective layer 400a, a second substrate 500, a connection wire LL, a planarization layer 600, a black matrix 700, a pattern layer 800, a coating layer 900, and the like.

The first substrate 100 including the groove G, the circuit layer 200, the liquid crystal layer 300, the sealant 310, the pad portion PAD, a bending wire BL, the first protective layer 400a, the second substrate 500, the connection wire LL, the planarization layer 600, the black matrix 700, the pattern layer 800, and the coating layer 900 are substantially the same as those of the display panel 10 according to the first example, so the same reference numerals are given to them, and redundant descriptions thereof may be omitted or simplified.

The display panel 10b according to the third example may include a first protective layer 400a formed by a patterning process using a photolithography mask. Here, the patterning process using a photolithography mask may improve the process precision for the formation of the first protective layer 400a. Accordingly, the first protective layer 400a may only be arranged over the planarization layer 240 to overlap the planarization layer 240, so that a portion of the first protective layer 400a may not cover the side surface 241 of the planarization layer 240 in the second non-display area NA2. Thus, the first protective layer 400a of the display panel 10b may be arranged at a predetermined position to protect the bending wire BL and the like.

Referring to FIG. 16, the display panel 10b according to the third example may be bent. For example, as the bending area BA is bent to have a predetermined radius of curvature, the display panel 10b may be bent so that the first area 110 and the second area 120 face each other.

Since the gate insulating layer 220, the first interlayer dielectric layer 230, and the second interlayer dielectric layer 260 made of an inorganic insulating material are not arranged in the bending area BA of the display panel 10a according to the example of the present disclosure, damage to the gate insulating layer 220, the first interlayer dielectric layer 230, and the second interlayer dielectric layer 260 due to bending may be prevented or reduced in advance.

As the bending area BA is bent, a light source 30 may be arranged between the first area 110 and the second area 120. Here, the light source 30 may emit light toward the first area 110. Accordingly, the light source 30 may overlap the first area 110 in the Z-axis direction.

The display device according to one or more examples of the present disclosure may be described as follows.

A display device according to one or more examples of the present disclosure may include a display panel including a groove and a circuit board connected to the display panel, the display panel includes a first substrate including a first area and a second area spaced apart from each other by the groove; a circuit layer arranged on the first area and including a transistor; a planarization layer extending in the circuit layer to be arranged over the groove; a bending wire arranged on the planarization layer; a first protective layer arranged over the bending wire; and a second substrate arranged over the first protective layer to overlap the first area and the second area of the first substrate.

According to one or more examples of the present disclosure, the display panel may further include a liquid crystal layer arranged between the circuit layer and the second substrate.

According to one or more examples of the present disclosure, the display panel may further include a planarization layer arranged on the liquid crystal layer and the first protective layer.

According to one or more examples of the present disclosure, the display panel may further include a sealant surrounding the liquid crystal layer, and the first protective layer may be spaced apart from the sealant.

According to one or more examples of the present disclosure, the display panel may further include a sealant surrounding the liquid crystal layer, and a portion of the sealant may be arranged in the inside of a groove concavely formed in the planarization layer.

According to one or more examples of the present disclosure, the display panel may further include a pad portion arranged on the second area, and a portion of the first protective layer may be arranged between the planarization layer and the pad portion.

According to one or more examples of the present disclosure, the display panel may further include a first dam and a second dam arranged to be spaced apart from each other over the planarization layer, and the first protective layer may be arranged between the first dam and the second dam.

According to one or more examples of the present disclosure, the first dam may overlap the first area and the second dam may overlap the second area.

According to one or more examples of the present disclosure, the planarization layer arranged over the groove may extend to overlap the second area.

According to one or more examples of the present disclosure, the first protective layer may be arranged over the planarization layer and may overlap the second area.

According to one or more examples of the present disclosure, the display panel may further include a pattern layer overlapping the groove, and the pattern layer may be arranged on the bending wire.

According to one or more examples of the present disclosure, the display panel may further include a coating layer arranged in the groove.

According to one or more examples of the present disclosure, the display panel may further include a second protective layer arranged over the groove, and the planarization layer may cover the second protective layer.

According to one or more examples of the present disclosure, the display panel may further include a first connection wire that contacts one side of the bending wire and a second connection wire that contacts the other side of the bending wire.

According to one or more examples of the present disclosure, the display panel may further include a second interlayer dielectric layer arranged over the planarization layer, the second interlayer dielectric layer may be arranged between the bending wire and the first connection wire and between the bending wire and the second connection wire, and the first connection wire and the second connection wire may be contact the bending wire through a contact hole in the second interlayer dielectric layer.

According to one or more examples of the present disclosure, the bending wire may include a material different from a material of the first connection wire and the second connection wire.

According to one or more examples of the present disclosure, the display panel may further include a first electrode arranged on the planarization layer, the bending wire may include a first layer and a second layer, and at least one of the first layer and the second layer may include the same metal layer as the first electrode.

According to one or more examples of the present disclosure, a portion of the first protective layer may be arranged in the inside of a groove concavely formed in the planarization layer.

According to one or more examples of the present disclosure, the first side surface of the first area and the second side surface of the second area may be inclined surfaces each having a predetermined slope.

According to one or more examples of the present disclosure, the first substrate and the second substrate may include a glass material.

The above description of the problem to be solved, the means to solve the problem, and the effect described above does not specify the essential features of the claims, and therefore the scope of the claims is not limited by what is described in the specification.

Although the examples of the present disclosure have been described in more detail with reference to the accompanying drawings, the present disclosure is not limited thereto and may be embodied in many different forms without departing from the technical concept of the present disclosure. Therefore, the examples disclosed in the present disclosure are provided for illustrative purposes only and are not intended to limit the technical concept of the present disclosure, and the scope of the technical concept of the present disclosure is not limited thereto. Therefore, it should be understood that the examples described above are illustrative in all aspects and do not limit the present disclosure. The scope of protection of the present disclosure should be construed on the basis of the following claims, and all technical concepts within the equivalent scope thereof should be construed as falling within the scope of the present disclosure.

### LIST OF REFERENCE NUMBERS

| | |
|---|---|
| 10, 10a, 10b: Display panel | 100: Substrate |
| 110: first area | 120: second area |
| 200: Circuit layer | 240: Planarization layer |
| 300: Liquid crystal layer | 400a: first protective layer |
| 500: second substrate | 600: planarization layer |
| 700: Black matrix | 800: Pattern layer |
| 900: Coating layer | BL: Bending wire |
| G: Groove | LL: Connection wire |
| PAD: Pad part | |

What is claimed is:

1. A display device comprising:
a first substrate including a first area and a second area that are spaced apart from each other by a groove;
a circuit layer arranged on the first area and including a transistor;
a planarization layer extending in the circuit layer to be arranged over the groove;
a bending wire arranged on the planarization layer;
a first protective layer arranged over the bending wire; and
a second substrate arranged over the first protective layer to overlap the first area and the second area of the first substrate.

2. The display device according to claim 1, further comprising:
a liquid crystal layer arranged between the circuit layer and the second substrate.

3. The display device according to claim 2, further comprising:
a planarization layer arranged on the liquid crystal layer and the first protective layer.

4. The display device according to claim 2, further comprising:
a sealant surrounding the liquid crystal layer,
wherein the first protective layer is spaced apart from the sealant.

5. The display device according to claim 2, further comprising:
a sealant surrounding the liquid crystal layer,
wherein a portion of the sealant is arranged in the inside of a groove, and the groove is concavely formed in the planarization layer.

6. The display device according to claim 1, further comprising:
a pad portion arranged on the second area,
wherein a portion of the first protective layer is arranged between the planarization layer and the pad portion.

7. The display device according to claim 1, further comprising:
a first dam and a second dam arranged to be spaced apart from each other over the planarization layer,
wherein the first protective layer is arranged between the first dam and the second dam.

8. The display device according to claim 7, wherein the first dam overlaps the first area, and the second dam overlaps the second area.

9. The display device according to claim 1, wherein the planarization layer arranged over the groove extends to overlap the second area.

10. The display device according to claim 9, wherein the first protective layer is arranged over the planarization layer and overlaps the second area.

11. The display device according to claim 1, further comprising:
a pattern layer overlapping the groove,
wherein the pattern layer is arranged on the bending wire.

12. The display device according to claim 11, further comprising:
a coating layer arranged in the groove.

13. The display device according to claim 1, further comprising:
a second protective layer arranged over the groove,
wherein the planarization layer covers the second protective layer.

14. The display device according to claim 1, further comprising:
a first connection wire and a second connection wire,
wherein the first connection wire contacts one side of the bending wire, and the second connection wire contacts the other side of the bending wire.

15. The display device according to claim 14, further comprising:
a second interlayer dielectric layer arranged over the planarization layer,
wherein the second interlayer dielectric layer is arranged between the bending wire and the first connection wire and between the bending wire and the second connection wire, and
wherein the first connection wire and the second connection wire contact the bending wire through a contact hole in the second interlayer dielectric layer.

16. The display device of claim 14, wherein the bending wire includes a material different from a material of the first connection wire and the second connection wire.

17. The display device according to claim 1, further comprising:
a first electrode arranged on the planarization layer,
wherein the bending wire includes a first layer and a second layer, and
wherein at least one of the first layer and the second layer includes the same metal layer as the first electrode.

18. The display device according to claim 1, wherein a portion of the first protective layer is arranged in the inside of a groove concavely formed in the planarization layer.

19. The display device according to claim 1, wherein a first side surface of the first area and a second side surface of the second area are inclined surfaces each having a predetermined slope.

20. The display device according to claim 1, wherein the first substrate and the second substrate include a glass material.
